(19) United States
(12) Patent Application Publication
(10) Pub. No.: US 2012/0054561 A1
(43) Pub. Date: Mar. 1, 2012

(54) NETWORK SYSTEM, INFORMATION PROCESSING APPARATUS, AND METHOD THEREOF

(75) Inventor: Kotaro Yamaguchi, Tokyo (JP)

(73) Assignee: CANON KABUSHIKI KAISHA, Tokyo (JP)

(21) Appl. No.: 13/198,046

(22) Filed: Aug. 4, 2011

(30) Foreign Application Priority Data
Aug. 27, 2010 (JP) 2010-191209

(51) Int. Cl. G06F 11/07; G06F 15/173

(52) U.S. Cl. 714/57; 714/E11.025

(57) ABSTRACT

A network system performs display control for displaying, on a display device, a monitoring screen using registration information and operational information on an image forming apparatus to be monitored. The display device displays a device list screen indicating a list of a plurality of image forming apparatuses to be monitored, and a failure list which is regularly updated without user operation. If an image forming apparatus is selected based on a user operation via the device list screen and details of the selected image forming apparatus is to be displayed, a detailed screen is displayed using the operational information. If failure information is selected via a user operation from the failure list which is regularly updated, a detailed screen on the failure information of the image forming apparatus in which the failure indicated by the selected failure information has occurred is displayed using the operational information.

### BACKGROUND OF THE INVENTION

1. Field of the Invention

The present invention relates to a technique for managing information about an image forming apparatus and remotely monitoring the operational status of the image forming apparatus.

2. Description of the Related Art

Conventionally, there is a system that performs maintenance of an image forming apparatus, such as a copying machine or a printer, by constantly monitoring the operational status including failure occurring in the image forming apparatus. Such a system provides, to a maintenance worker via a screen display, information about the failure that has occurred, and prompts the maintenance worker to perform a maintenance work. For example, the system displays the screen by displaying a list of a plurality of image forming apparatuses that are being monitored. Occurrence of the failure in the image forming apparatus is then indicated by a simplified display, such as by displaying a message, i.e., “a failure occurred”. Further, the occurrence of the failure is displayed by switching an icon of the image forming apparatus in which the failure has occurred to an icon indicating a failure occurrence status, and displaying the new icon. Furthermore, the information about the failures that occur in the plurality of image forming apparatuses may be managed and popped up as update information as necessary (refer to Japanese Patent Application Laid-Open No. 2004-246822).

On the other hand, there is a system which displays various types of detailed information about the image forming apparatus being monitored. Such detailed information includes information about functions included in the image forming apparatus, network information, e.g., an address, and installation site information. Such a system displays the list of image forming apparatuses being monitored, and separately displays a new screen for displaying the detailed information about the image forming apparatus selected from the list.

However, if the maintenance worker is to confirm the details of the status of the image forming apparatus in which the failure has occurred in the conventional monitoring system, it becomes necessary for the maintenance worker to separately perform operations for displaying a plurality of screens indicating the detailed information. The maintenance worker is required to perform the operation every time a new failure occurs in the image forming apparatus. The screen operation thus becomes complex for the maintenance worker who is constantly monitoring a large number of image forming apparatuses. Further, if the operation of the monitoring screen becomes complex, it becomes difficult for the maintenance worker to appropriately and promptly monitor the statuses of the image forming apparatuses to be managed. This may result in a delay in performing the maintenance work on the image forming apparatuses.

### SUMMARY OF THE INVENTION

One aspect of the present invention is directed to a method for appropriately and promptly monitoring the status of an image forming apparatus to be managed.

According to another aspect of the present invention, a network system including a plurality of image forming apparatuses and a monitoring system for monitoring the plurality of image forming apparatuses, includes a storing unit configured to store registration information including identification information of the plurality of image forming apparatuses to be monitored, and operational information including failure information and counter information collected from the plurality of image forming apparatuses, a first collection unit configured to collect, at predetermined timing, counter information from an image forming apparatus to be monitored, a second collection unit configured to collect, at timing in which a failure has occurred in an image forming apparatus to be monitored, failure information about the failure, and a display control unit configured to display, on a display device, a monitoring screen using at least one of the registration information and the operational information stored in the storing unit, wherein the display control unit displays, on the display device, a device list screen indicating a list of the plurality of image forming apparatuses to be monitored using the registration information, a failure list to be regularly updated without user operation using the failure information collected by the second collection unit and stored in the storing unit, a detailed screen using the operational information stored in the storing unit when the display control unit receives, based on a user operation via a device list screen, a selection of an image forming apparatus and an instruction to display details of the selected image forming apparatus, and a detailed screen related to failure information of an image forming apparatus in which a failure indicated by the failure information has occurred using the operational information stored in the storing unit, in response to receiving as a user operation a selection of the failure information from the regularly updated failure list.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of the entire network system according to an exemplary embodiment of the present invention.

FIG. 2 illustrates a hardware configuration of a monitoring apparatus.

FIG. 3 illustrates a data structure of monitoring information.

FIG. 4 illustrates how each monitoring screen is called up.

FIG. 5 illustrates a display example of a main screen.

FIG. 6 illustrates a display example of a device list screen.

FIG. 7 illustrates a display example of a counter screen.

FIG. 8 illustrates a display example of a failure summary screen.

FIG. 9 illustrates a display example of a failure history screen.

FIG. 10 illustrates a display example when a stock management screen is called up from the device list screen.

FIG. 11 illustrates a display example when the stock management screen is called up from a main screen.

FIG. 12 illustrates a module configuration based on a monitoring application program.

FIG. 13 is a flowchart illustrating a display process of the monitoring screen.

FIG. 14 is a flowchart illustrating a display process of the monitoring screen.

FIGS. 15A and 15B are schematic diagrams illustrating a status transition table of the monitoring screen.

FIGS. 16A and 16B illustrate specific states of a monitor based on an operation performed by the maintenance worker.

### DESCRIPTION OF THE EMBODIMENTS

Various exemplary embodiments, features, and aspects of the invention will be described in detail below with reference to the drawings.

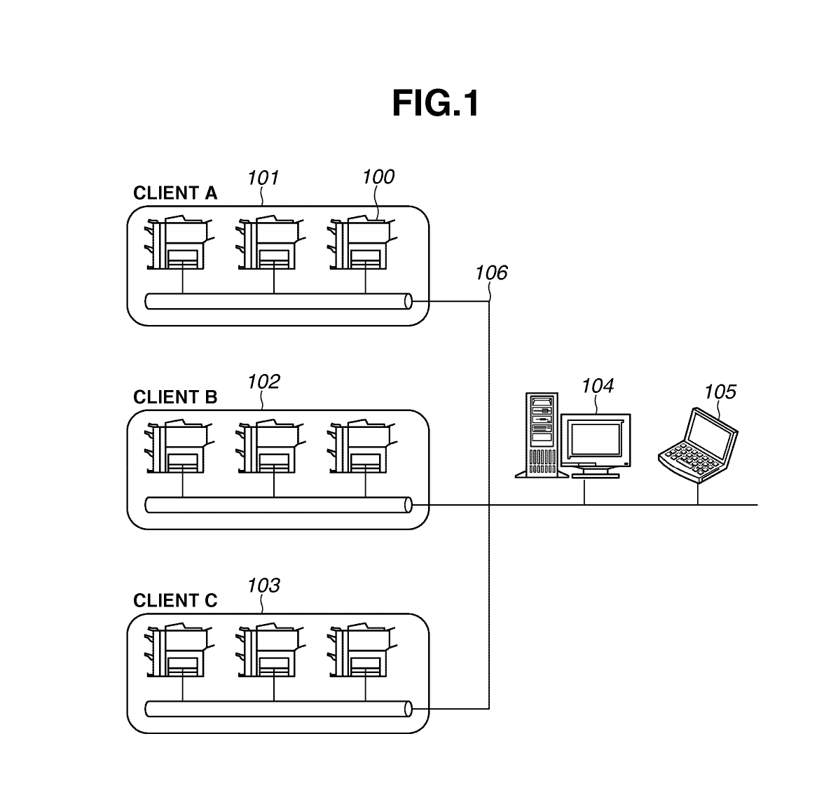

FIG. 1 illustrates a network system according to an exemplary embodiment of the present invention. Referring to FIG. 1, the network system includes an image forming apparatus 100, such as a copying machine or a printer, having a network print function, a facsimile function, and a copy function. A monitoring apparatus 104 manages detailed information about the image forming apparatus 100 and monitors the operational status of the image forming apparatus 100. A client personal computer (PC) 105 acquires information managed by the monitoring apparatus 104 and displays a monitoring screen. The maintenance worker of the image forming apparatus 100 can view the monitoring screen displayed on the client PC 105 and confirm the information necessary for performing the maintenance work.

In the example illustrated in FIG. 1, a plurality of image forming apparatuses 100 exist on a network of each of a plurality of clients, i.e., client A 101, client B 102, and client C 103. Further, the plurality of image forming apparatuses 100, the monitoring apparatus 104, and the client PC 105 are connected to a network 106. The client network may also be connected the monitoring system including the monitoring apparatus 104 via the Internet. In such a case, the monitoring system can integrally manage and monitor remote image forming apparatuses of the plurality of clients.

The image forming apparatus 100 to be monitored in the network system operates to communicate the operational information thereof to the monitoring apparatus 104. More specifically, the image forming apparatus 100 to be monitored notifies the monitoring apparatus 104 of the counter information indicating operating amounts of components in the image forming apparatus 100 and the number of sheets that have been used. Further, the image forming apparatus 100 notifies the monitoring apparatus 104 of the failure information indicating an error, a paper jam, or toner run-out that has occurred. In such a case, the image forming apparatus 100 notifies the monitoring apparatus 104 of the counter information at regular timing such as once a day, and of the failure information immediately when the failure has occurred.

If the image forming apparatus 100 performs a print operation so that the toner becomes consumed and runs out, the image forming apparatus 100 cannot further perform the print operation unless the toner is replenished. In such a case, the client loads a new cartridge on the image forming apparatus 100 and restores the image forming apparatus 100 to a printable state. It is thus desirable to maintain a state in which the client constantly has an extra supply of the toner cartridge for replenishing the toner so that the image forming apparatus can be promptly restored. To solve such a problem, the maintenance worker refers to stock information managed by the monitoring system and ships as necessary the extra supply of toner cartridges to the client. More specifically, the monitoring system includes a function for managing the stock quantity of the extra supply of consumables that the client has and notifying the maintenance worker of the stock quantity as necessary. The monitoring system thus supports the work to be performed by the maintenance worker.

The monitoring apparatus 104 manages, as registration information in an internal storage device (i.e., a hard disk drive (HDD)) or an externally-connected database, the detailed information of the image forming apparatus to be monitored. The registration information includes an identification (ID) of the image forming apparatus, product information indicating a model or a function, network information such as an internet protocol (IP) address, and client information. Further, the monitoring apparatus 104 collects, from the image forming apparatus to be monitored, the counter information and the failure information, and stores and manages the information in the storage device. As a result, the monitoring apparatus 104 manages operational information such as the current failure occurrence status, failure history to date, and various counter information of the plurality of image forming apparatuses, associated with the registration information.

Furthermore, the monitoring apparatus 104 manages, for each client, stock information including types and available quantities of the consumables such as the toner cartridge used in the image forming apparatus in a client environment. Moreover, the monitoring apparatus 104 transmits, to the client PC 105, information such as the counter information and the failure information stored and managed in the monitoring apparatus 104, in response to an inquiry from the client PC 105. The client PC 105 thus acquires the operational information such as the counter information and the failure information from the monitoring apparatus 104, displays the various monitoring screens, and provides the information to the maintenance worker.

According to the present exemplary embodiment, the client PC 105 connected to the monitoring system including the monitoring apparatus 104 displays the various monitoring screens. However, the various monitoring screens may be displayed in the monitoring system, and in particular on the monitoring apparatus 104. In such a case, the maintenance worker views the various monitoring screens on the monitoring apparatus 104, so that the effect according to the present exemplary embodiment may be similarly achieved.

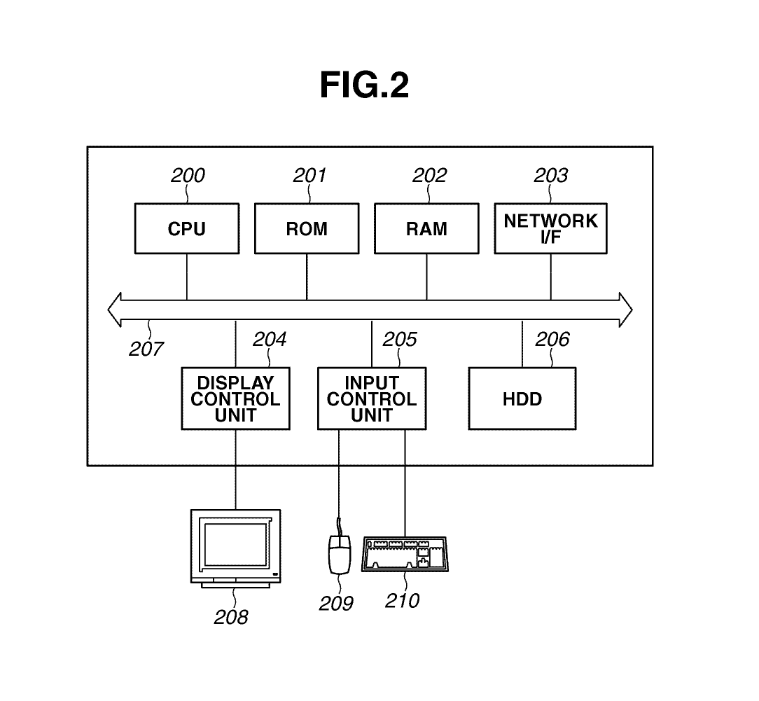

FIG. 2 illustrates hardware configurations of the monitoring apparatus 104 and the client PC 105. Referring to FIG. 2, a central processing unit (CPU) 200 controls the entire monitoring apparatus 104 and the client PC 105. The CPU 200 executes an operating system (OS) and a monitoring application program stored in an HDD 206, and performs the processes in the monitoring apparatus 104 and the client PC 105. According to the present exemplary embodiment, all of the processes performed by the monitoring apparatus 104 and the client PC 105 are controlled by the CPU 200. A read-only memory (ROM) 201 stores programs such as a basic input/output (I/O) program. When the monitoring apparatus 104 is activated, the CPU 200 reads from the ROM 201 and executes the basic I/O program. A random access memory (RAM) 202 is a work memory area for executing the programs. A network interface (I/F) 203 communicates with the image forming apparatus 100 via the network. A display control unit 204 controls displaying of the screens on a display device such as a monitor 208 connected thereto. An input control unit 205 performs control of input from a mouse 209 and a keyboard 210 connected thereto. Such various types of hardware are disposed on a system bus 207.

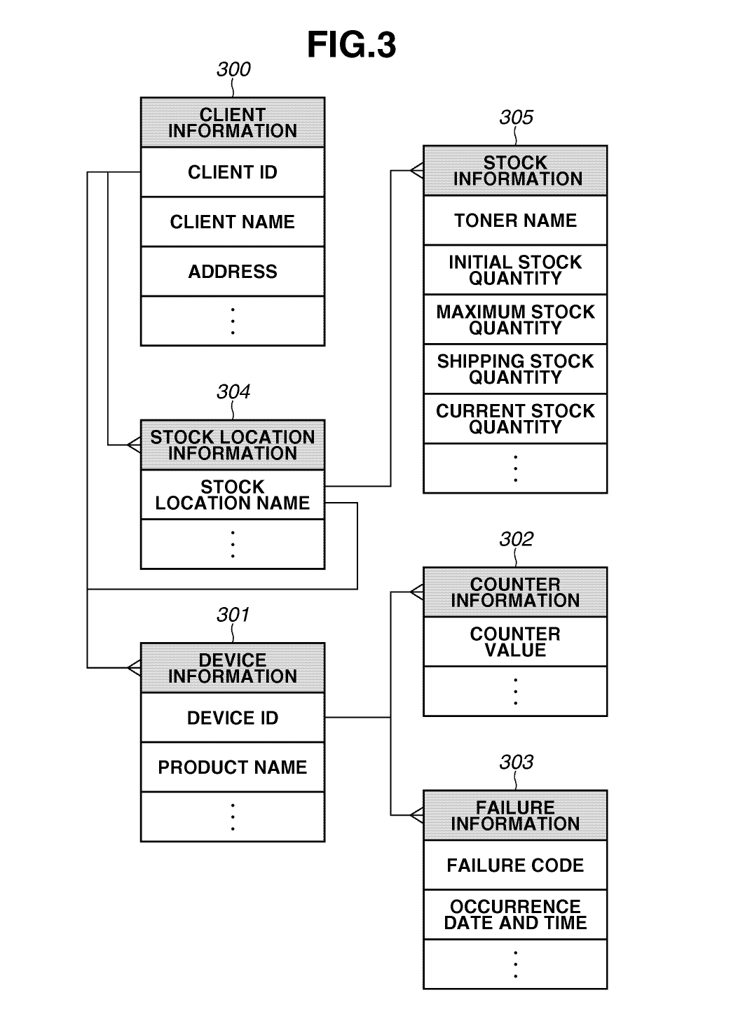

FIG. 3 illustrates a data structure of the monitoring information managed in the HDD of the monitoring apparatus 104. Referring to FIG. 3, a client information table 300 manages information on each of the client in which the image forming apparatus 100 to be monitored is installed. The client information table 300 stores a client ID for uniquely identifying the client, a client name, and a client address. A device information table 301 manages information about the image forming apparatus 100 to be monitored, associated with the information on the client in which the image forming apparatus 100 is installed. The device information table 301 stores a device ID for uniquely identifying the device, and a product name. A managing user such as the maintenance worker registers the information included in the client information table 300 and in the device information table 301.

A counter information table 302 manages the counter information acquired from the image forming apparatus 100. The counter information table 302 is configured to manage the counter information associated with the device information of the image forming apparatus 100 from which the counter information is acquired. The counter information table 302 stores the counter information indicating various counter values, such as the number of printed sheets for each mode (i.e., total print, color print/copy, and monochrome print/copy) and a usage frequency of the components. A failure information table 303 manages the failure information acquired from the image forming apparatus 100. The failure information table 303 is configured to manage the failure information associated with the device information of the image forming apparatus 100 from which the counter information is acquired. The failure information table 303 stores a failure code indicating the failure content, and date and time at which the failure occurred.

A stock location information table 304 manages the location of the consumables such as the extra supply of the toner cartridge stocked by the client (hereinafter referred to as a stock location). The stock location information table 304 stores the stock location name. A stock information table 305 manages the toner cartridges disposed in the stock location. The stock information table 305 manages the stock information associated with each of the stock location information. The stock information table 305 stores the identification information of the toner cartridge (i.e., name and type), initial stock quantity, maximum stock quantity, shipping stock quantity, and current stock quantity. The maximum stock quantity indicates the maximum stock quantity that can be stocked in the stock location. The shipping stock quantity is a threshold value for the maintenance worker to determine the necessity of shipping the extra supply of toner cartridges to the client. If the current stock quantity becomes less than or equal to the shipping stock quantity, the maintenance worker prepares to ship the toner cartridges.

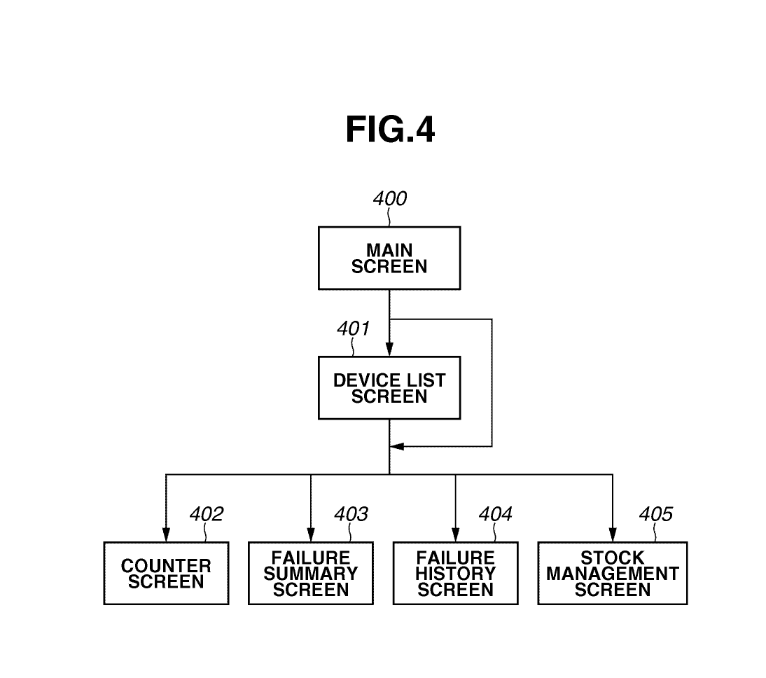

FIG. 4 illustrates configurations of each of the monitoring screens and how each monitoring screen is called up, when the client PC 105 acquires and displays, on the screen, various monitoring information managed in the monitoring apparatus 104. Referring to FIG. 4, the monitoring screen according to the present system includes a main screen 400, a device list screen 401, a counter screen 402, a failure summary screen 403, a failure history screen 404, and a stock management screen 405. The device list screen 401 is called up from the main screen 400. The counter screen 402, the failure summary screen 403, the failure history screen 404, and the stock management screen 405 are called up from either the main screen 400 or the device list screen 401. The screens are called up when the screen jumps to another screen according to the operation of the maintenance worker on the screen.

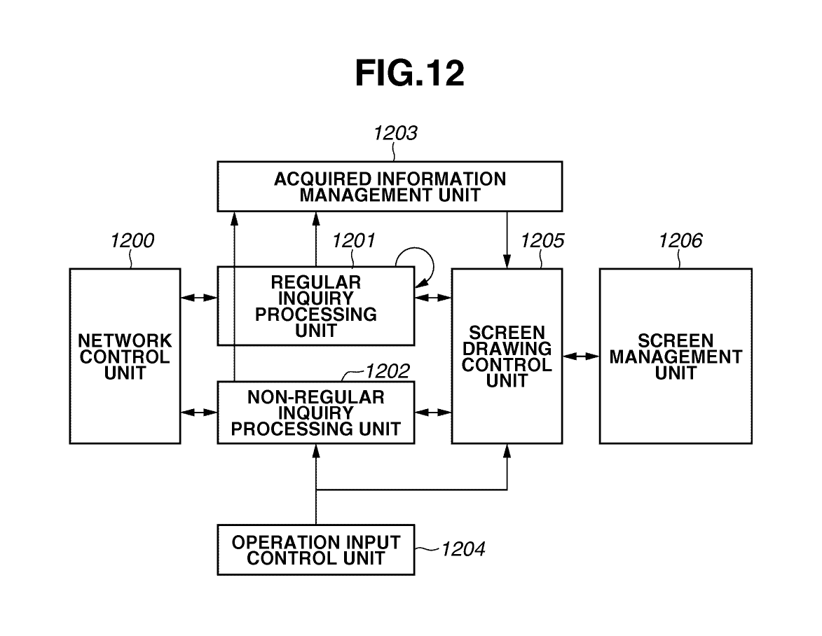

FIG. 12 illustrates a logical module configuration for describing a process performed when the monitoring application program is executed. The process performed by the monitoring application program operating on the client PC 105 will be described below with reference to FIG. 12.

Referring to FIG. 12, a network control unit 1200 performs communication protocol control when the PC 105 communicates with the monitoring apparatus 104 via the network 106. A regular inquiry processing unit 1201 regularly inquires the monitoring apparatus 104 and acquires the failure information. Such a process is regularly performed while the monitoring application program is operating on the client PC 105. A non-regular inquiry processing unit 1202 inquires the monitoring apparatus 104 according to an input by a specific operation. The non-regular inquiry processing unit 1202 thus acquires the client information, the device information, the counter information, the failure information, the stock location information, and the stock information. An acquired information management unit 1203 stores in the HDD and manages the various types of information acquired from the monitoring apparatus 104. An operation input control unit 1204 detects the input from the maintenance worker by operating the keyboard or the mouse, and notifies the other processing units on the detected input content. A screen drawing control unit 1205 draws each monitoring screen. A screen management unit 1206 manages the display status of each monitoring screen and determines transition of the screens according to the input.

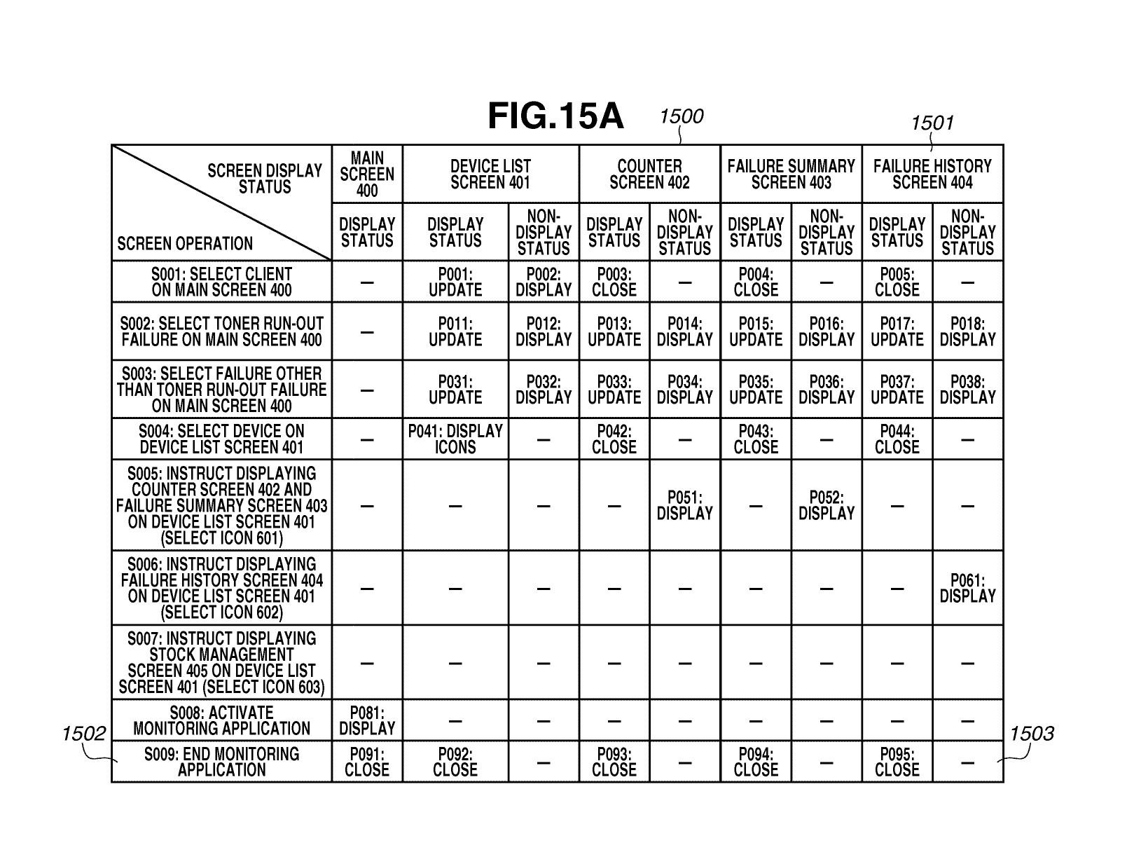

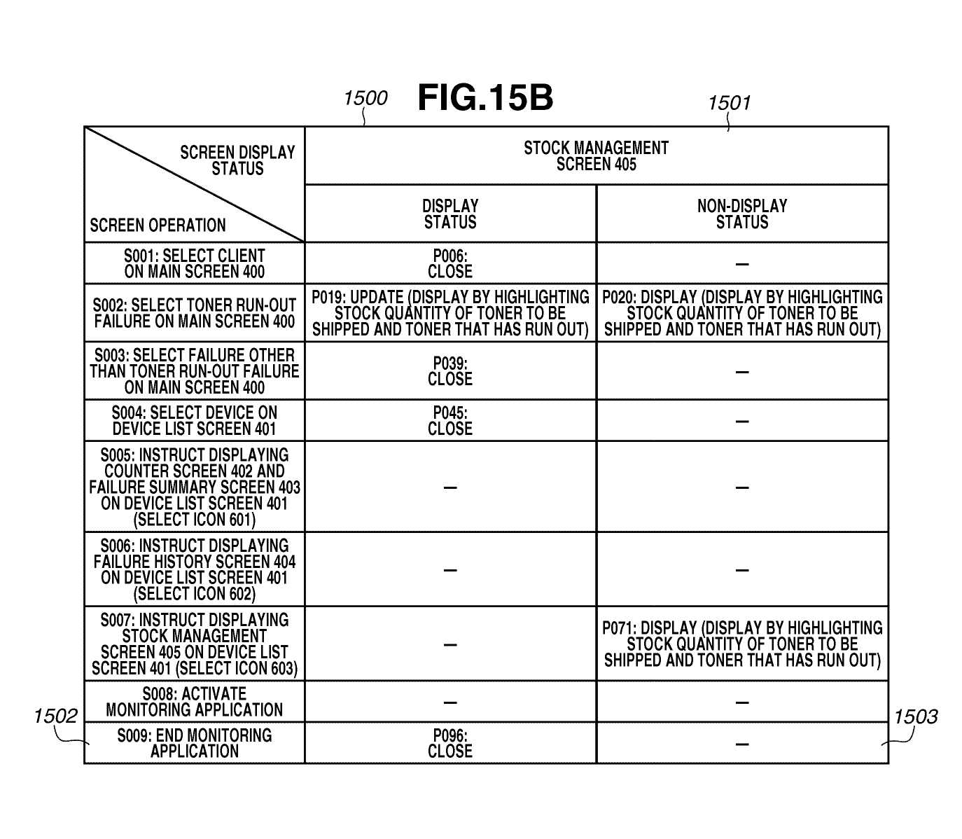

FIGS. 15A and 15B are schematic diagrams illustrating a status transition table used by the screen management unit 1206 to determine screen transition. Referring to FIGS. 15A and 15B, a status transition table 1500 is managed by the screen management unit 1206. More specifically, the status transition illustrated in FIGS. 15A and 15B may be stored as a file or described as a sequence in a program. A row 1501 of the status transition table 1500 describes the display statuses of each monitoring screen. Further, a column 1502 describes the screen operations performed by the maintenance worker to be associated with the screen transition. The screen display process to be performed which is uniquely determined by a combination of the display status and the screen operation is described in each box 1503.

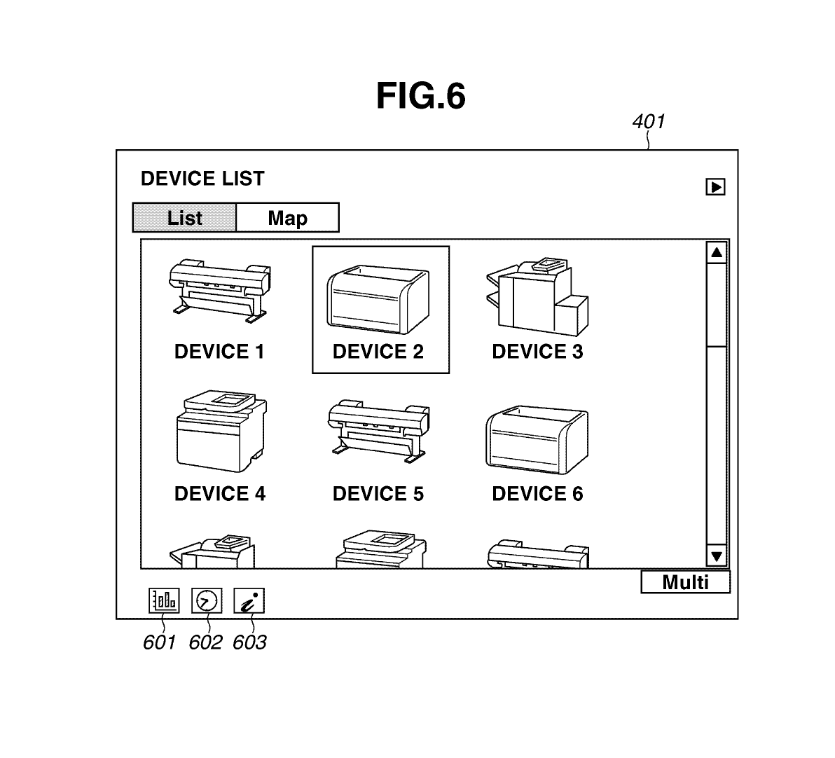

For example, if the device list screen 401 illustrated in FIG. 4 is not being displayed when the maintenance worker performs a screen operation for selecting the client on the main screen 400 (corresponding to S001), the corresponding description, i.e., “P002: display”, indicates opening the device list screen 401. Further, if the failure summary screen 403 is not being displayed when the maintenance worker selects an icon 601 illustrated in FIG. 6 on the device list screen 401 (corresponding to S006), the corresponding description, i.e., “P052: display”, indicates opening the failure summary screen 403. The screen management unit 1206 determines the screen transition according to the description in the status transition table 1500.

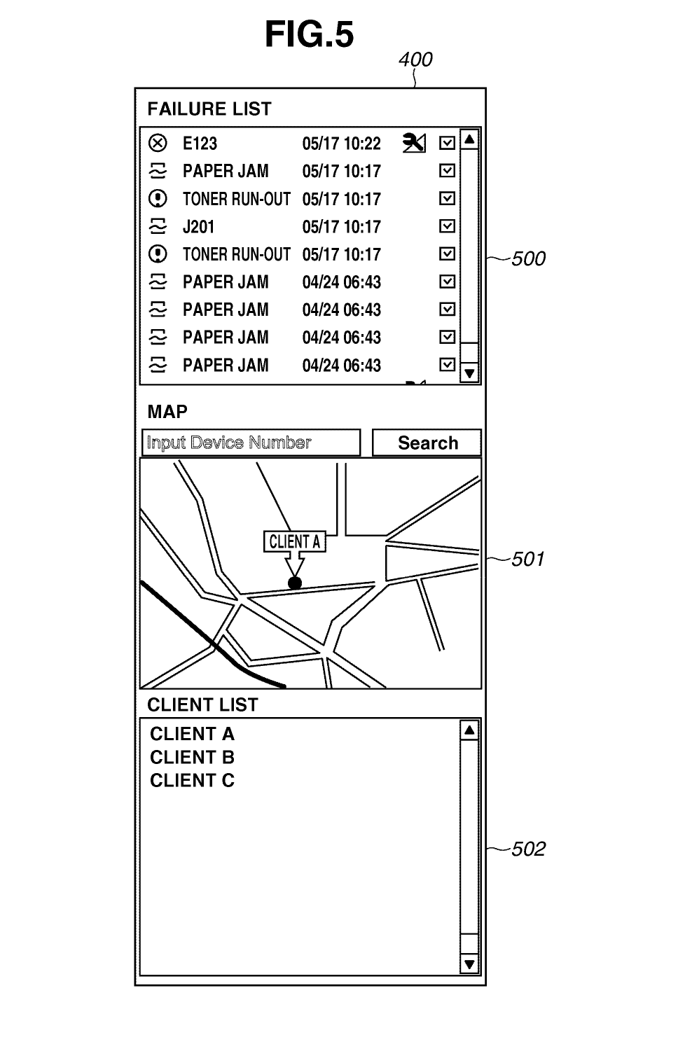

FIG. 5 illustrates a display example of the main screen 400. Referring to FIG. 5, the screen drawing control unit 1205 displays, in the main screen 400, a failure list 500 indicating the failure information acquired by the regular inquiry processing unit 1201. Further, the screen drawing control unit 1205 displays a map 501 linked to the address of the client. Furthermore, the screen drawing control unit 1205 displays a client list 502 based on the client information acquired by the non-regular inquiry processing unit 1202. The client list 502 is a static display based on the client information acquired when the screen is generated. In contrast, the failure list 500 is a dynamic display which is updated by information that is regularly acquired after the screen is generated. Further, the failure information displayed in the failure list 500 is the information about the failures that occurred in all the image forming apparatuses installed in all of the client networks, to be monitored by the system.

FIG. 6 illustrates a display example of the device list screen 401. Referring to FIG. 6, the screen drawing control unit 1205 displays in the device list screen 401 the device list based on the device information acquired by the non-regular inquiry processing unit 1202. Further, the screen drawing control unit 1205 displays, when a specific device is selected in the device list, icons 601, 602, and 603 in the lower portion of the device list screen 401. The maintenance worker can instruct displaying of the other monitoring screens by operating on the icons. More specifically, the icon 601 is a button for displaying the counter screen 402 and the failure summary screen 403, the icon 602 is a button for displaying the failure history screen 404, and the icon 603 is a button for displaying the stock management screen 405.

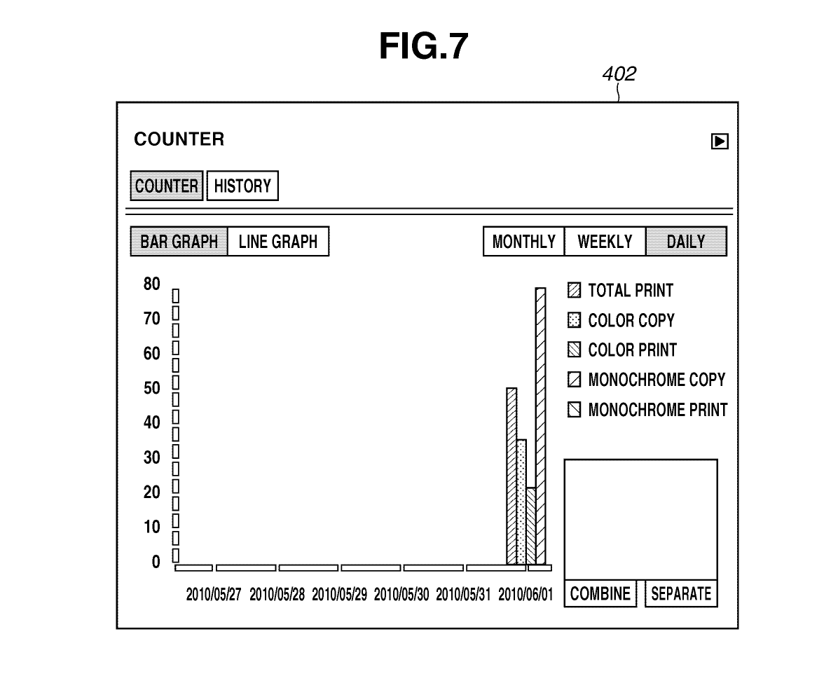

FIG. 7 illustrates a display example of the counter display screen 402. Referring to FIG. 7, the screen drawing control unit 1205 displays, on the counter display screen 402, a bar graph according to the counter information of a specific image forming apparatus, based on the counter information acquired by the non-regular inquiry processing unit 1202. The horizontal axis of the bar graph can be switched between daily, weekly, and monthly display, so that the maintenance worker can refer to a transition of the counter information over time. Further, the monitoring screen may be switched to displaying a line graph instead of the bar graph.

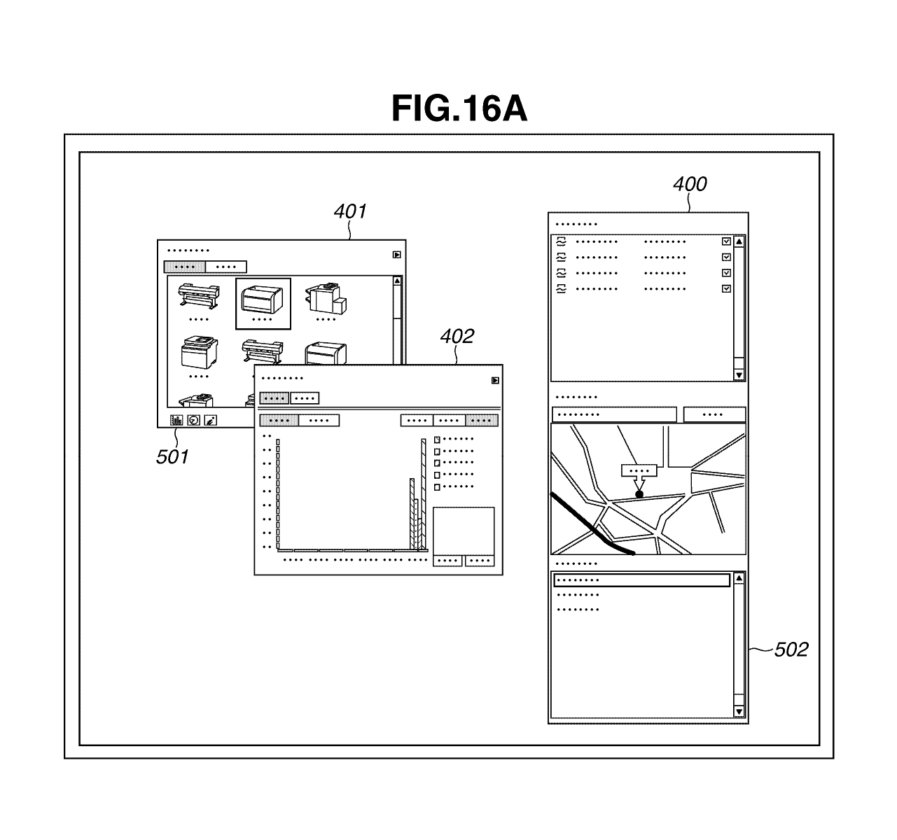

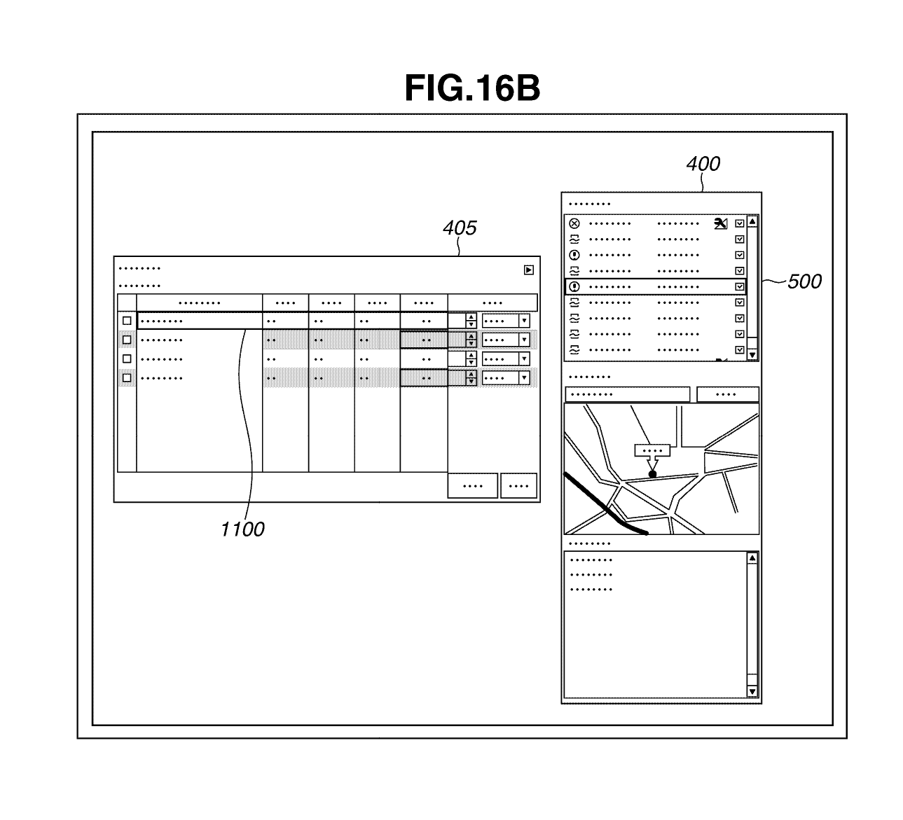

FIG. 16A illustrates the specific state of the monitor 208 when the counter display screen 402 is displayed. Referring to FIG. 16A, the display example illustrates a case where the maintenance worker has selected “client A” from the client list 502, selected “device 2” on the device list screen 401, and designated the icon 601.

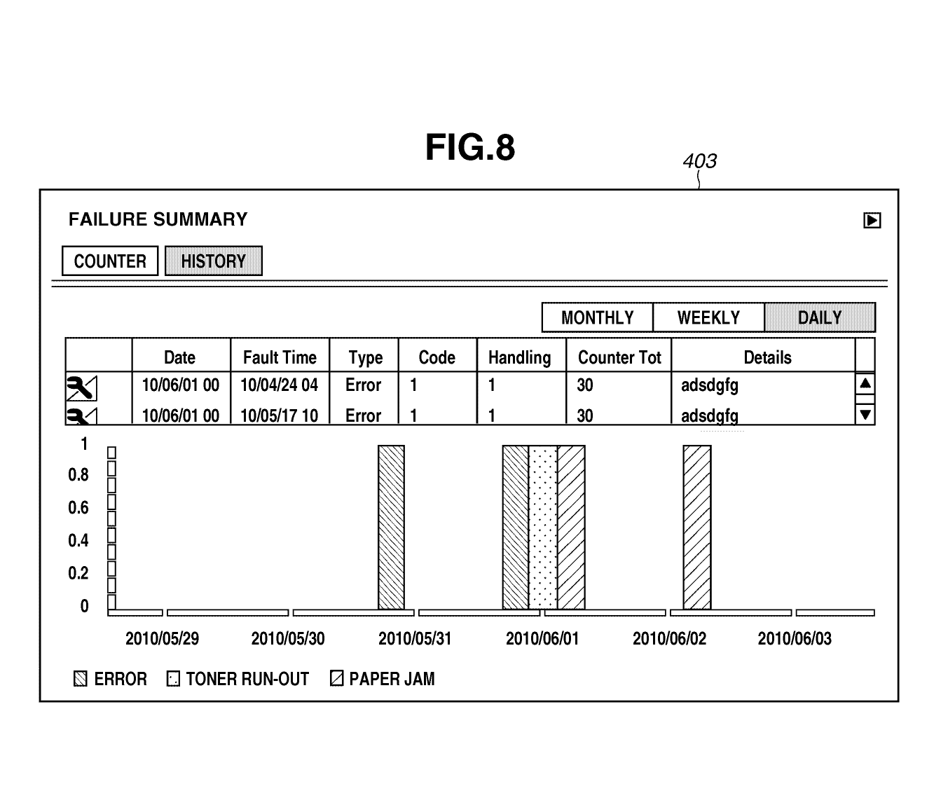

FIG. 8 illustrates a display example of the failure summary screen 403. Referring to FIG. 8, the screen drawing control unit 1205 displays the list of the failure information related to a specific image forming apparatus, based on the failure information acquired by the regular inquiry processing unit 1201. Further, the screen drawing control unit 1205 counts the numbers of failures for each type of failure, such as an error, a paper jam, and toner run-out, and displays the bar graphs based on the numbers.

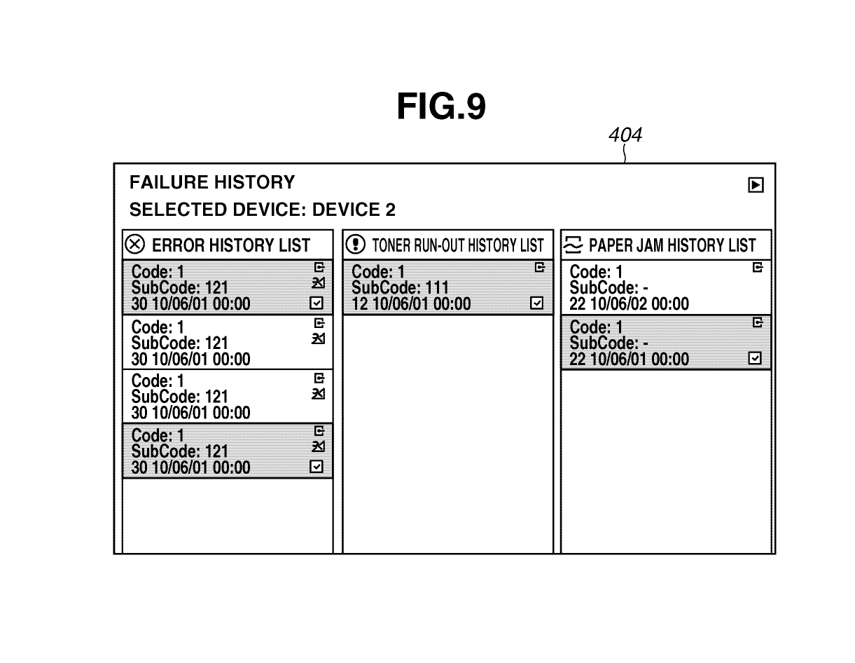

FIG. 9 illustrates a display example of the failure history screen 404. Referring to FIG. 9, the screen drawing control unit 1205 displays, as lists, histories of the failure information that occurred in a specific image forming apparatus within a predetermined period. The screen drawing control unit 1205 displays the lists based on the failure information acquired by the regular inquiry processing unit 1201. The screen drawing control unit 1205 displays, in separate regions, the lists for each type of the failure, i.e., error, paper jam, and toner run-out. A portion of the failures may be displayed so that the status of the failure can be confirmed, such as whether the failure has been treated by the maintenance worker.

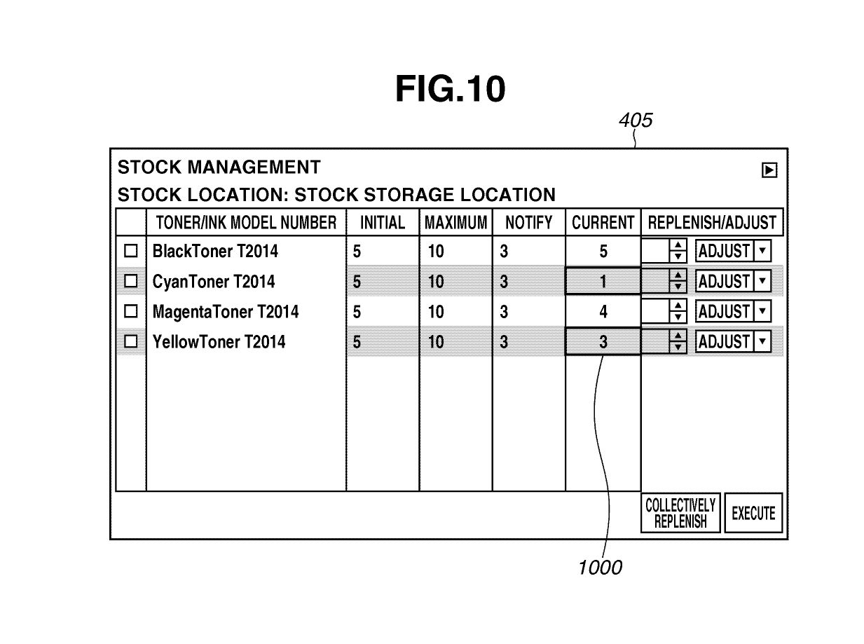

FIG. 10 illustrates an example of the stock management screen 405 displayed when the maintenance worker has pressed the icon 603 on the device list screen 401. Referring to FIG. 10, the screen drawing control unit 1205 displays the stock information of the stock location which is associated with the image forming apparatus selected on the device list screen 401. The screen drawing control unit 1205 displays the stock information based on the stock location information and the stock information acquired by the non-regular inquiry processing unit 1202. The screen drawing control unit 1205 performs control to display and highlight the current stock quantity of the toner cartridge which has become less than or equal to notifying stock quantity, as indicated by shaded regions 1000. The maintenance worker can thus appropriately recognize the consumable such as the toner cartridge that is necessary to be shipped to the client.

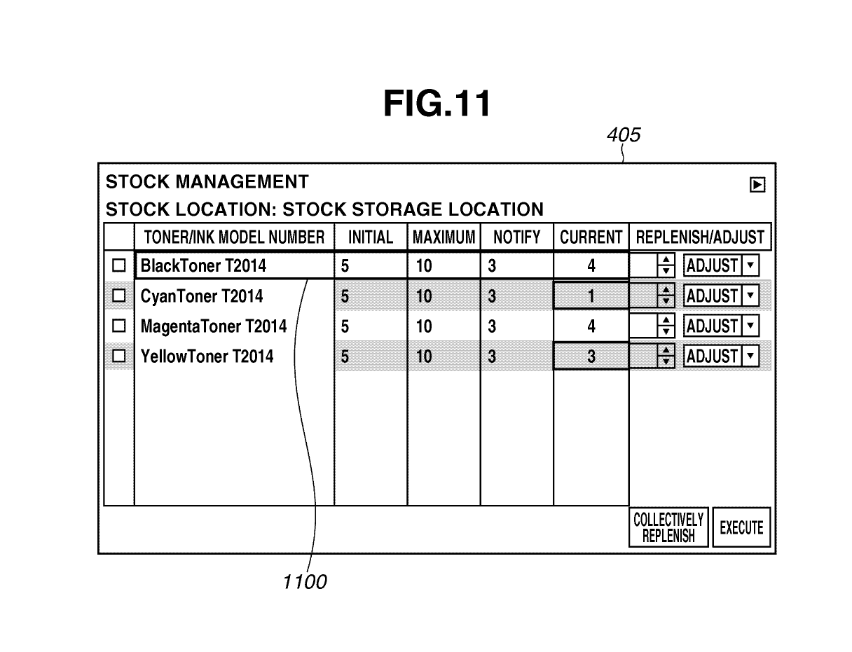

FIG. 11 illustrates an example of the stock management screen 405 displayed when the maintenance worker has selected the toner run-out failure displayed in the failure list 500 on the main screen 400. Notification on the remaining amount of consumables, such as the toner run-out, includes the identification information of the image forming apparatus in which the failure has occurred, information on the type of the consumable, and information on the date and time of occurrence. The screen drawing control unit 1205 displays the stock information of the stock location which is associated with the selected image forming apparatus in which the toner run-out failure has occurred, based on the stock location information and the stock information acquired by the non-regular inquiry processing unit 1202. The screen drawing control unit 1205 performs control to display and highlight the current stock quantity of the toner which has become less than or equal to the notifying stock quantity, as indicated by the shaded regions 1000 illustrated in FIG. 10. Further, the screen drawing control unit 1205 performs control to display and highlight (stressing) a row including the toner name of the toner that has run out, as indicated by a highlighted row 1100. The maintenance worker can thus appropriately recognize the consumable such as the toner cartridge that is necessary to be shipped to the client, and the consumable that has run out.

FIG. 16B illustrates the specific state of the monitor 208 when the maintenance worker has selected a failure in the failure list 500 and the stock management screen 405 is displayed. More specifically, it is assumed that the maintenance worker has confirmed the counter information of the image forming apparatus using the monitoring screen illustrated in FIG. 16A, and is generating a report to the client. Further, the failure list 500 is dynamically updating the failure information. If the maintenance worker then recognizes in the failure list 500 that the toner run-out failure has newly occurred, the maintenance worker selects the failure information thereof. A detailed screen (i.e., the stock management screen 405) on the failure information (i.e., toner run-out) of the image forming apparatus in which the selected failure information has occurred is thus automatically displayed, as illustrated in FIG. 16B. The detailed screen is automatically displayed by the maintenance worker performing such a selecting operation once, without designation of the apparatus on the client list 502 and the device list screen 401.

The maintenance worker can thus recognize in the failure list displayed on the main screen that a failure has occurred which is to be treated with high priority, even when the maintenance worker is performing a monitoring work. The maintenance worker can then immediately refer to the related detailed screen. Further, the failure list 500 displays the failure information of all image forming apparatuses of all clients. The maintenance worker can thus recognize the failure occurring in the image forming apparatus of another client even when monitoring the image forming apparatus of “client A” as illustrated in FIG. 16A. As a result, according to the present exemplary embodiment, the delay in treating the failures by the maintenance worker can be prevented.

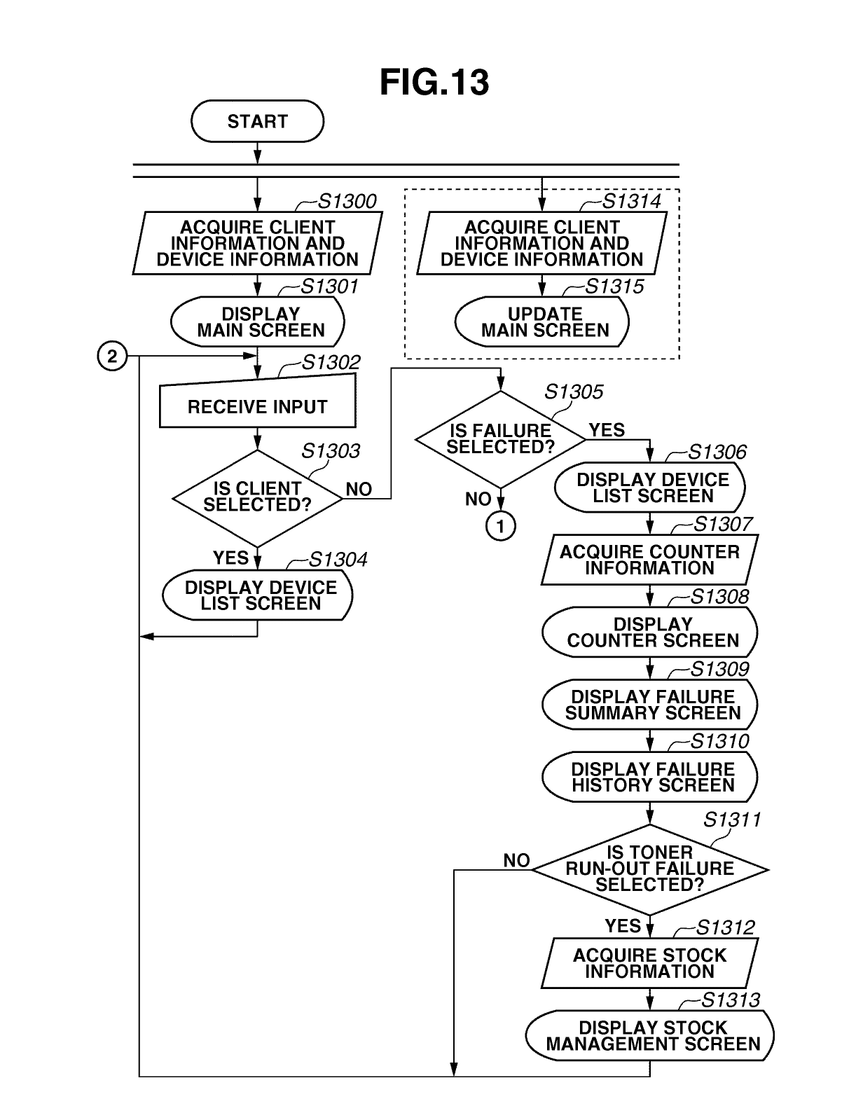

FIG. 16B illustrates the case where only the detailed screen which is most strongly related to the selected failure information (i.e., the stock management screen 405) is displayed, for ease of description. However, the detailed screen which is most strongly related to the selected failure information may be displayed as a first screen, and the device list screen 401 of the apparatus in which the failure has occurred and the other monitoring screens may also be arranged and displayed on the monitor. This is as illustrated in FIGS. 15A and 15B and FIG. 13 to be described below.

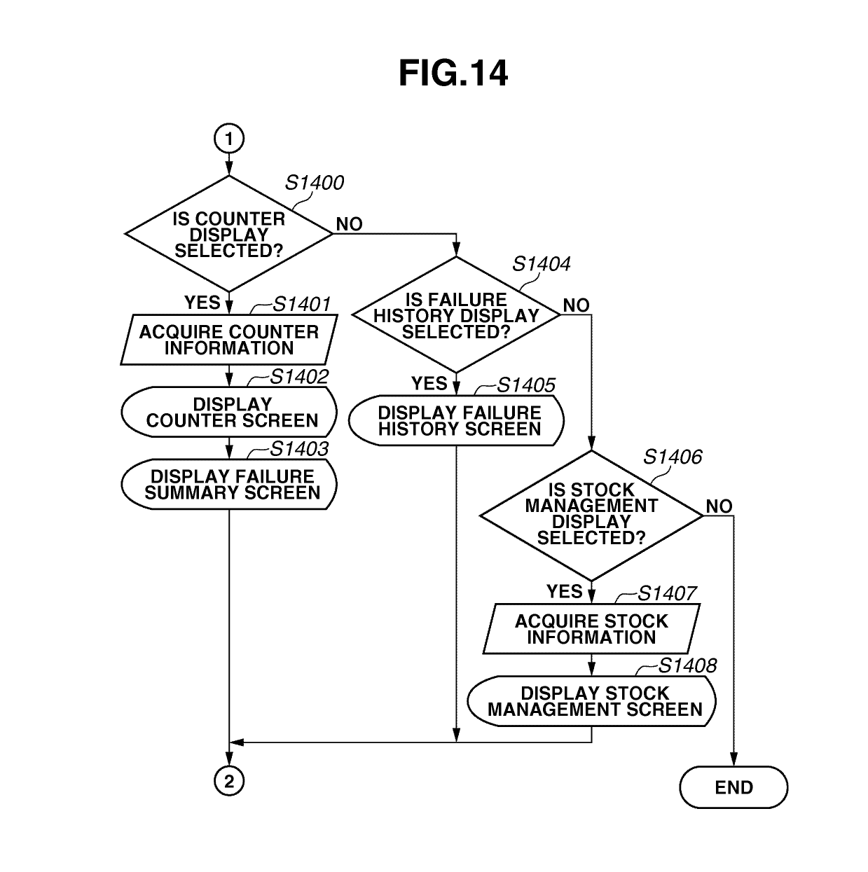

FIGS. 13 and 14 are flowcharts illustrating processes for controlling display of the monitoring screen, which is realized by executing the monitoring application program running on the client PC 105. In step S1300 illustrated in FIG. 13, the maintenance worker activates the monitoring application program on the client PC 105. The non-regular inquiry processing unit 1202 then inquires the monitoring apparatus 104 and acquires the client information and the device information. In step S1301, the non-regular inquiry processing unit 1202 displays the main screen 400 based on the acquired client information and the device information.

In step S1314, the regular inquiry processing unit 1201 inquires the monitoring apparatus 104, asynchronously with the operation of a user such as the maintenance worker and other display control, and acquires the information about the failures occurring in all of the image forming apparatuses. For example, the regular inquiry processing unit 1201 acquires the information on the failure that has newly occurred after the previous inquiry. In step S1315, the regular inquiry processing unit 1201 updates the display of the failure list 500 in the main screen 400, using the acquired failure information. The regular inquiry processing unit 1201 regularly executes (e.g., every minute) the processes of step S1314 and step S1315, until the monitoring application program is completed. As a result, the failure list 500 constantly displays the newest state in the main screen 400.

In step S1302, after the main screen 400 is displayed, the operation input control unit 1204 stands by for an operation input of the maintenance worker. In step S1303, the operation input control unit 1204 determines whether an input indicating selection of a specific client on the client list 502 in the main screen 400 is received. If the operation input control unit 1204 has received an input indicating selection of a client (YES in step S1303), the process proceeds to step S1304. In step S1304, the screen drawing control unit 1205 newly displays the device list screen 401 indicating the image forming apparatus of the selected client while continuing to display the main screen 400. The operation input control unit 1204 then returns to the operation input standby process. The display process of the device list screen 401 will be described in detail with reference to the state transition table 1500 illustrated in FIGS. 15A and 15B.

Referring to FIGS. 15A and 15B, the selection of the specific client by the maintenance worker corresponds to the screen operation “S001: select client in main screen 400” described in the status transition table 1500. Upon detecting input of the screen operation, the operation input control unit 1204 transmits the screen operation content to the screen management unit 1206 and inquires on the content of the screen display process. The screen management unit 1206, which has received the inquiry, determines the content of the screen display process in the status transition table 1500, based on the screen operation content and the display status of each monitoring screen.

According to the present example, it is assumed that only the main screen 400 is being displayed, and the screen management unit 1206 determines that the device list screen 401 is to be displayed (corresponding to P002). The screen management unit 1206 then transmits the determined content of the screen display process to the screen drawing control unit 1205. The screen drawing control unit 1205 thus displays the device list screen 401 according to the content of the received screen display process. If the device list screen 401 is not being displayed when the maintenance worker has performed the screen operation for selecting the client on the main screen 400 (corresponding to S001), the corresponding description “P002: display” indicates opening the device list screen 401.

In step S1305, the screen drawing control unit 1205 determines whether the input received in step S1302 is selection of the failure information in the failure list 500 on the main screen 400. If the screen drawing control unit 1205 determines that the input indicating selection of the specific failure information is received (YES in step S1305), the process proceeds to step S1306. In step S1306, the screen drawing control unit 1205 newly displays the device list screen 401 of the client whose apparatus is the apparatus in which the failure indicated by the selected failure information has occurred. The screen drawing control unit 1205 displays the device list screen 401 while continuing to display the main screen 400.

In step S1307, the non-regular inquiry processing unit 1202 inquires the monitoring apparatus 104 and acquires the counter information of the apparatus in which the failure indicated by the selected failure information has occurred. In step S1308, the screen drawing control unit 1205 newly displays the counter display screen 402 based on the acquired counter information. In step S1309, the screen drawing control unit 1205 displays the failure summary screen 403. In step S1310, the screen drawing control unit 1205 displays the failure history screen 404. The failure information to be used in displaying the failure history screen 404 may be newly acquired from the monitoring apparatus 104. The failure information that the regular inquiry processing unit 1201 has previously acquired from the monitoring apparatus 104 in step S1314 may also be used.

In step S1311, the screen drawing control unit 1205 determines whether the failure selected on the failure list 500 in the main screen 400 is the toner run-out failure. If the selected failure information is the toner run-out failure (YES in step S1311), the process proceeds to step S1312. In step S1312, the non-regular inquiry processing unit 1202 inquires the monitoring apparatus 104 and acquires the stock location information and the stock information. The non-regular inquiry processing unit 1202 then newly displays the stock management screen 405 based on the acquired stock location information and the stock information, and the process returns to the operation standby process (step S1302). In such a case, the stock management screen 405 to be displayed is as illustrated in FIG. 11.

A process performed when the input received in step S1302 does not indicate selection of the failure information on the failure list 500 displayed on the main screen 400 will be described below with reference to FIG. 14. More specifically, the process performed when the maintenance worker operates on the icons 601, 602, and 603 on the device list screen 401 will be described below.

In step S1400, the screen drawing control unit 1205 determines whether the input indicates selection of the icon 601 on the device list screen 401. If the input indicates selection of the icon 601 (YES in step S1400), the screen drawing control unit 1205 determines that the maintenance worker has instructed displaying the counter screen 402 and the failure summary screen 403. In step S1401, the non-regular inquiry processing unit 1202 inquires the monitoring apparatus 104 and acquires the counter information of the image forming apparatus selected in the device list screen 401. In step S1402, the non-regular inquiry processing unit 1202 newly displays the counter display screen 402 based on the acquired counter information. In step S1403, the screen drawing control unit 1205 displays the failure summary screen 403, and the process returns to the operation input standby process (step S1302 illustrated in FIG. 13). The failure information which the regular inquiry processing unit 1201 has previously acquired from the monitoring apparatus 104 in step S1314 may also be used to display the failure summary screen 403.

In step S1404, the screen drawing control unit 1205 determines whether the input indicates selection of the icon 602 on the device list screen 401. If the input indicates selection of the icon 602 (YES in step S1404), the screen drawing control unit 1205 determines that the maintenance worker has instructed displaying the failure history screen 404. In step S1405, the screen drawing control unit 1205 displays the failure history screen 404, and the process returns to the operation input standby process (step S1302 illustrated in FIG. 13). The failure information which the regular inquiry processing unit 1201 has previously acquired from the monitoring apparatus 104 in step S1314 may also be used to display the failure history screen 404.

In step S1406, the screen drawing control unit 1205 determines whether the input indicates selection of the icon 603 on the device list screen 401. If the input indicates selection of the icon 603 (YES in step S1406), the screen drawing control unit 1205 determines that the maintenance worker has instructed displaying the stock management screen 405. In step S1407, the non-regular inquiry processing unit 1202 inquires the monitoring apparatus 104 and acquires the stock location information and the stock information. In step S1408, the non-regular inquiry processing unit 1202 displays the stock management screen 405. The process returns to the operation input standby process (step S1302 illustrated in FIG. 13).

On the other hand, if the screen drawing control unit 1205 determines that the input does not indicate selection of the icon 603 (YES in step S1406), the screen drawing control unit 1205 determines that the input indicates ending the monitoring application (not illustrated). In such a case, the process ends.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-191209 filed Aug. 27, 2010, which is hereby incorporated by reference herein in its entirety.

What is claimed is:

1. A network system including a plurality of image forming apparatuses and a monitoring system for monitoring the plurality of image forming apparatuses, the network system comprising:
a storing unit configured to store registration information including identification information of the plurality of image forming apparatuses to be monitored, and operational information including failure information and counter information collected from the plurality of image forming apparatuses;
a first collection unit configured to collect, at predetermined timing, counter information from an image forming apparatus to be monitored;
a second collection unit configured to collect, at timing in which a failure has occurred in an image forming apparatus to be monitored, failure information about the failure; and
a display control unit configured to display, on a display device, a monitoring screen using at least one of the registration information and the operational information stored in the storing unit,
wherein the display control unit displays, on the display device,
a device list screen indicating a list of the plurality of image forming apparatuses to be monitored using the registration information, a failure list to be regularly updated without user operation using the failure information collected by the second collection unit and stored in the storing unit, a detailed screen using the operational information stored in the storing unit when the display control unit receives, based on a user operation via a device list screen, a selection of an image forming apparatus and an instruction to display details of the selected image forming apparatus, and a detailed screen related to failure information of an image forming apparatus in which a failure indicated by the failure information has occurred using the operational information stored in the storing unit, in response to receiving as a user operation a selection of the failure information from the regularly updated failure list.

2. The network system according to claim 1, wherein the registration information includes at least product information and client information of each of the plurality of image forming apparatuses.

3. The network system according to claim 1, wherein the detailed screen includes at least one of a counter screen for performing display using counter information of each image forming apparatus, a failure summary screen for displaying information on a failure that has occurred in each image forming apparatus, a failure history screen for displaying a history of information on a failure that has occurred in each image forming apparatus, and a stock management screen for displaying a stock of consumables used in each image forming apparatus.

4. The network system according to claim 1, wherein the storing unit further stores stock information indicating information on a stock of consumables used in an image forming apparatus to be monitored,
wherein the failure information includes a remaining amount notification that indicates a type of a consumable used in an image forming apparatus in which a failure has occurred and information about a remaining amount of the consumable, and
wherein the display control unit displays, if a selection of the remaining amount notification is received as a user operation from the failure list, a stock management screen on the display device as a detailed screen on the failure information, using the stock information stored in the storing unit.

5. The network system according to claim 4, wherein the display control unit displays and highlights, when a selection of the remaining amount notification is received as a user operation from the failure list and the display control unit displays the stock management screen on the display device as the detailed screen on the failure information using stock information stored in the storing unit, stock information on a type of a consumable indicated in the remaining amount notification.

6. A method in a network system including a plurality of image forming apparatuses and a monitoring system for monitoring the image forming apparatuses, the method comprising:
storing registration information including identification information of a plurality of image forming apparatuses to be monitored, and operational information including failure information and counter information collected from the plurality of image forming apparatuses;
collecting, at predetermined timing, counter information from an image forming apparatus to be monitored;
collecting, at timing in which a failure has occurred in the image forming apparatus to be monitored, failure information about the failure;
displaying, on a display device, a monitoring screen using at least one of the stored registration information and operational information;
displaying, on the display device, a device list screen indicating a list of the plurality of image forming apparatuses to be monitored using the registration information, and a failure list to be regularly updated without user operation using the collected and stored failure information;
displaying, when receiving, based on a user operation via a device list screen, a selection of an image forming apparatus and an instruction to display details of the selected image forming apparatus, a detailed screen on the display device using the stored operational information; and
displaying, on the display device, a detailed screen related to failure information of an image forming apparatus in which a failure indicated by the failure information has occurred using the stored operational information, in response to receiving as a user operation a selection of the failure information from the regularly updated failure list.

7. An information processing apparatus including a display device, the information processing apparatus communicating with a monitoring system for monitoring a plurality of image forming apparatuses, the information processing apparatus comprising:
an acquisition unit configured to acquire, from the monitoring system, registration information including identification information of the plurality of image forming apparatuses to be monitored, and operational information including failure information and counter information collected from the plurality of image forming apparatuses; and
a display control unit configured to display, on the display device, a monitoring screen using at least one of the registration information and the operational information acquired by the acquisition unit,
wherein the display control unit displays, on the display device, a device list screen indicating a list of the plurality of image forming apparatuses to be monitored using the registration information, a failure list which is regularly updated without user operation using the failure information acquired by the acquisition unit, a detailed screen using the operational information acquired by the acquisition unit when the display control unit receives, based on a user operation via a device list screen, a selection of an image forming apparatus and an instruction to display details of the selected image forming apparatus, and a detailed screen related to failure information of an image forming apparatus in which a failure indicated by the failure information has occurred using the operational information acquired by the acquisition unit, in response to receiving as a user operation a selection of the failure information from the regularly updated failure list.

8. The information processing apparatus according to claim 7, wherein the registration information includes at least product information and client information of each image forming apparatus.

9. The information processing apparatus according to claim 7, wherein the detailed screen includes at least one of a counter screen for performing display using counter information of each image forming apparatus, a failure summary screen for displaying information on a failure that has occurred in each image forming apparatus, a failure history screen for displaying a history of information on a failure that has occurred in each image forming apparatus, and a stock management screen for displaying a stock of consumables used in each image forming apparatus.

10. The information processing apparatus according to claim 7, wherein the acquisition unit further acquires stock information indicating information on a stock of consumables used in an image forming apparatus to be monitored,
wherein the failure information includes a remaining amount notification that indicates a type of a consumable used in an image forming apparatus in which a failure has occurred and information about a remaining amount of the consumable, and
wherein the display control unit displays, if a selection of the remaining amount notification is received as a user operation from the failure list, a stock management screen on the display device as detailed screen on the failure information, using the stock information acquired by the acquisition unit.

11. A method in an information processing apparatus including a display device, the information processing apparatus communicating with a monitoring system for monitoring a plurality of image forming apparatuses, the method comprising:
acquiring, from the monitoring system, registration information including identification information of a plurality of image forming apparatuses to be monitored, and operational information including failure information and counter information collected from the plurality of image forming apparatuses;
displaying, on the display device, a monitoring screen using at least one of the acquired registration information and operational information;
displaying, on the display device, a device list screen indicating a list of the plurality of image forming apparatuses to be monitored using the registration information, and a failure list which is regularly updated without user operation using the acquired failure information;
displaying, when receiving, based on a user operation via a device list screen, a selection of an image forming apparatus and an instruction to display details of the selected image forming apparatus, a detailed screen on the display device using the stored operational information; and
displaying, on the display device, a detailed screen related to failure information of an image forming apparatus in which a failure indicated by the failure information has occurred using the acquired operational information, in response to receiving as a user operation a selection of the failure information from the regularly updated failure list.

12. A computer-readable storage medium storing a program for causing a computer to execute a method for communicating with a monitoring system for monitoring a plurality of image forming apparatuses and displaying the plurality of image forming apparatuses, the method comprising:
acquiring, from the monitoring system, registration information including identification information of a plurality of image forming apparatuses to be monitored, and operational information including failure information and counter information collected from the plurality of image forming apparatuses;
displaying, on the display device, a monitoring screen using at least one of the acquired registration information and operational information;
displaying, on the display device, a device list screen indicating a list of the plurality of image forming apparatuses to be monitored using the registration information, and a failure list to be regularly updated without user operation using the acquired failure information;
displaying, when receiving, based on a user operation via a device list screen, a selection of an image forming apparatus and an instruction to display details of the selected image forming apparatus, a detailed screen on the display device using the stored operational information; and
displaying, on the display device, a detailed screen related to failure information of an image forming apparatus in which a failure indicated by the failure information has occurred using the acquired operational information, in response to receiving as a user operation a selection of the failure information from the regularly updated failure list.
